(19) United States
(12) Patent Application Publication
(10) Pub. No.: US 2025/0345920 A1
(43) Pub. Date: Nov. 13, 2025

(54) REPLACEMENT HEAD EXTERNAL HANGING DEVICE AND HAND-HELD ELECTRIC POWER TOOL ASSEMBLY

(71) Applicant: Yantai Greenery Tools Co., Ltd., Yantai (CN)

(72) Inventors: Changlei FAN, Yantai (CN); Bo YU, Yantai (CN); Yongchao XIE, Yantai (CN)

(21) Appl. No.: 18/761,221

(22) Filed: Jul. 1, 2024

(30) Foreign Application Priority Data
May 13, 2024 (CN) 202410589747.9

(51) Int. Cl. B25F 5/02

(52) U.S. Cl. CPC B25F 5/029

(57) ABSTRACT

Provided are a replacement head external hanging device and a hand-held electric power tool assembly, the replacement head external hanging device is mounted on a hand-held electric power tool, the replacement head external hanging device includes a binding mounting belt and a storage member, and the binding mounting belt is configured to be wound on the hand-held electric power tool; and the storage member is provided with a storage portion, the storage portion is configured to store and place a replacement head, and the storage member is mounted on the hand-held electric power tool through the binding mounting belt. The arrangement of the replacement head external hanging device is convenient for a user to quickly replace the replacement head, which saves time for the user to rummage in a tool box or a tool kit for the replacement head.

### CROSS REFERENCE TO RELATED APPLICATIONS

This application claims foreign priority of Chinese Patent Application No. 202410589747.9, filed on May 13, 2024 in the China National Intellectual Property Administration, the disclosures of all of which are hereby incorporated by reference.

### TECHNICAL FIELD

The embodiment of the present application relates to the technical field of electric power tools, and particularly to a replacement head external hanging device and a hand-held electric power tool assembly.

### BACKGROUND OF THE PRESENT INVENTION

Hand-held electric power tools such as electric drills, electric screwdrivers and electric hammers are a kind of electric power tools that are convenient to carry and operate.

In related arts, the hand-held electric power tools such as electric drills, electric screwdrivers and electric hammers are usually provided with a plurality of replacement heads with different specifications and models, and users may choose replacement heads with appropriate specifications and models for construction according to use scenarios. For example, the electric drills are usually provided with a plurality of drill bits with different specifications and models, and users may choose drills according to hole sizes; and for another example, the electric screwdrivers are usually provided with a plurality of screwdriver bits (batch bits), and users may choose appropriate screwdriver bits to operate according to screws.

In the use of the hand-held electric power tools such as electric drills, electric screwdrivers and electric hammers, it is often necessary to replace the replacement head. However, the replacement head is usually stored in a tool box or a tool kit, and users need to rummage in the tool box or the tool kit when they need to replace the replacement head, causing the problems of inconvenient replacement of the replacement head and waste of time on rummage.

### SUMMARY OF THE PRESENT INVENTION

The embodiment of the present application provides a replacement head external hanging device and a hand-held electric power tool assembly for solving the technical problems of inconvenient replacement and waste of time on rummage when a replacement head of a hand-held electric power tool is replaced.

In order to solve the above technical problems, the embodiment of the present application provides the following technical solution.

The embodiment of the present application provides a replacement head external hanging device used for being mounted on a hand-held electric power tool, wherein the replacement head external hanging device includes:
a binding mounting belt, wherein the binding mounting belt is configured to be wound on the hand-held electric power tool; and
a storage member, wherein the storage member is provided with a storage portion, the storage portion is configured to store and place a replacement head, and the storage member is mounted on the hand-held electric power tool through the binding mounting belt.

The embodiment of the present application has the beneficial effects that: the replacement head external hanging device provided by the embodiment of the present application includes the binding mounting belt and the storage member, and the storage member is used for storing and placing the replacement head of the hand-held electric power tool, for example, when the hand-held electric power tool is an electric drill, the replacement head is a drill bit correspondingly, when the hand-held electric power tool is an electric screwdriver, the replacement head is a screwdriver bit correspondingly, and when the hand-held electric power tool is an electric hammer, the replacement head is an electric hammer driver bit correspondingly. The storage member is mounted on the hand-held electric power tool through the binding mounting belt, a user may place a commonly used replacement head in the storage member, when the user uses the hand-held electric power tool and needs to replace the replacement head, a required replacement head may be directly taken from the storage member and mounted on the hand-held electric power tool, the removed replacement head may be placed in the storage member, and by this arrangement, an appropriate replacement head can be got quickly, so that the replacement of the replacement head is more convenient, time for a user to rummage in a tool box or a tool kit for the replacement head is saved, and the removed replacement head can be placed in the storage member, which is convenient to store and not easy to lose.

In one possible embodiment, the binding mounting belt is an elastic belt.

In one possible embodiment, the storage member is provided with a binding portion;
the binding mounting belt is provided with a tightening edge, and the tightening edge tightens and fixes the binding portion between the tightening edge and the hand-held electric power tool; and
the binding portion of the storage member is tightened and fixed through the tightening edge, so that the storage member is mounted on the hand-held electric power tool.

In one possible embodiment, the tightening edge includes a first tightening edge and a second tightening edge; and
the binding portion includes a first binding edge and a second binding edge, the first binding edge and the second binding edge are located on two opposite sides of the storage member, the first binding edge is tightened between the first tightening edge and the hand-held electric power tool, and the second binding edge is tightened between the second tightening edge and the hand-held electric power tool.

In one possible embodiment, the hand-held electric power tool includes a main body portion and a handle portion, and the handle portion is connected with the main body portion;
the binding mounting belt includes a binding belt body and a connecting buckle, the binding belt body is provided with a first mounting opening and a second mounting opening, and the first mounting opening and the second mounting opening are arranged at an interval in a length direction of the binding belt body;
the binding belt body is sleeved on a junction of the handle portion and the main body portion from the first mounting opening, and the binding belt body is sleeved on a head portion of the main body portion from the second mounting opening; and
the connecting buckle connects two ends of the binding belt body in the length direction, and the connecting buckle is arranged at a tail end of the main body portion.

In one possible embodiment, one end of the handle portion close to the main body portion extends to the head portion of the main body portion in an extending direction of the main body portion to form a handle extension edge, and an end portion of the handle extension edge close to the head portion of the main body portion is provided with an illuminating lamp;

a light penetration opening is arranged between the first mounting opening and the second mounting opening;
the binding belt body between the first mounting opening and the light penetration opening is tightened on one side of the handle extension edge far away from the main body portion; and
the binding belt body between the second mounting opening and the light penetration opening is tightened on one side of the handle extension edge close to the main body portion.

In one possible embodiment, the binding belt body is provided with a third mounting opening, and the third mounting opening is located on one side of the main body portion far away from the handle portion;
in a width direction of the binding belt body, two side edges of the binding belt body at the first mounting opening are respectively a first side edge and a second side edge, two side edges of the binding belt body at the third mounting opening are respectively a third side edge and a fourth side edge, and the first side edge and the third side edge are on the same side; and
the first side edge serves as the first tightening edge, the third side edge serves as the second tightening edge, and the storage portion is located between the first side edge and the third side edge, or, the second side edge serves as the first tightening edge, the fourth side edge serves as the second tightening edge, and the storage portion is located between the second side edge and the fourth side edge, or, the third side edge serves as the first tightening edge, the fourth side edge serves as the second tightening edge, and the storage portion is located between the third side edge and the fourth side edge.

In one possible embodiment, one end of the binding belt body in the length direction is provided with a first connecting opening, and the other end of the binding belt body is provided with a second connecting opening; and
the connecting buckle is connected with the first connecting opening and the second connecting opening.

In one possible embodiment, the connecting buckle is provided with a magnetic member capable of adsorbing a ferromagnetic substance.

In one possible embodiment, the connecting buckle includes a connecting edge, a first connecting hook and a second connecting hook;
the connecting edge is provided with a first end and a second end which are opposite, the first end is bent towards one side of the connecting edge close to the hand-held electric power tool to form the first connecting hook, and the second end is bent towards one side of the connecting edge far away from the hand-held electric power tool to form the second connecting hook;
the first connecting hook is hooked to one end of the binding belt body in the length direction, and the second connecting hook is hooked to the other end of the binding belt body in the length direction; and
the magnetic member is wrapped in the connecting edge and located in an area of the connecting member opposite to the first connecting hook.

In one possible embodiment, the binding portion further includes a connecting portion;
the first binding edge and the second binding edge are respectively connected to two opposite sides of the connecting portion; and
the storage portion is connected to the connecting portion.

In one possible embodiment, the first binding edge includes an arc-shaped edge, an extension edge and a blocking protrusion;
one side of the arc-shaped edge in a circumferential direction is connected with the connecting portion, the other side of the arc-shaped edge is connected with the extension edge, and an opening of the arc-shaped edge faces away from the hand-held electric power tool;
two ends of the extension edge in a length direction respectively extend to two sides of the arc-shaped edge in a length direction, and extend out of two ends of the arc-shaped edge in the length direction, two ends of the extension edge extending out of the arc-shaped edge are respectively provided with a protruding edge, and each protruding edge forms a clamping opening with an end portion of the arc-shaped edge on a corresponding side;
the blocking protrusion is connected to one surface of the extension edge facing away from the hand-held electric power tool;
the first binding edge is configured to tighten the first tightening edge on the arc-shaped edge, the blocking protrusion blocks the first tightening edge from being separated from the arc-shaped edge, the first tightening edge is clamped in the clamping opening, and the protruding edge is pressed on the first tightening edge to block the first tightening edge from being separated from the arc-shaped edge; and
a structure of the second binding edge is the same as that of the first tightening edge.

In one possible embodiment, the connecting portion is provided with at least one mounting hole; and
the storage portion is provided with a mounting protrusion, a number of mounting protrusions is the same as that of mounting holes and the mounting protrusions are in one-to-one correspondence with the mounting holes, and among corresponding mounting protrusions and mounting holes, the mounting protrusion penetrates through the mounting hole and is limited and fixed by the mounting hole.

In one possible embodiment, the storage portion is provided with at least one storage hole; and
the storage hole is configured to insert and store the replacement head.

In one possible embodiment, a middle portion of the storage hole is provided with an avoidance opening; and
when a plurality of storage holes are provided, the plurality of storage holes are distributed at intervals in a first direction, the avoidance opening of each storage hole is penetrated, and the first direction is perpendicular to an axial direction of the storage hole.

The embodiment of the present application further provides a hand-held electric power tool assembly, and the hand-held electric power tool assembly includes a hand-held electric power tool and the replacement head external hanging device according to any one of the solutions above, wherein:
the binding mounting belt of the replacement head external hanging device is wound on the hand-held electric power tool, and the storage member of the replacement head external hanging device is mounted on the hand-held electric power tool through the binding mounting belt.

The beneficial effects of the hand-held electric power tool provided by the embodiment of the present application are the same as those of the replacement head external hanging device above, which will not be repeated herein.

In addition to the above technical problems solved by the present application, the technical features constituting the technical solutions and the beneficial effects brought by the technical features of these technical solutions, other technical problems that can be solved by the replacement head external hanging device and the hand-held electric power tool assembly provided by the present application, other technical features included in the technical solutions and the beneficial effects brought by these technical features will be further described in detail in specific embodiments.

### DESCRIPTION OF THE DRAWINGS

The drawings herein are incorporated into the specification and constitute a part of the specification, show embodiments that conform to the present application, and are used for describing a principle of the present application together with the specification.

FIG. 1 is a schematic diagram of a binding mounting belt in an embodiment of the present application;

FIG. 2 is a schematic diagram of a storage member in the embodiment of the present application;

FIG. 3 is a schematic diagram of a binding portion in the embodiment of the present application;

FIG. 4 is a schematic diagram of a replacement head external hanging device mounted on a hand-held electric power tool in the embodiment of the present application; and

FIG. 5 is a schematic diagram of a connecting buckle in the embodiment of the present application.

### DESCRIPTION OF REFERENCE NUMERALS

100 refers to binding mounting belt;
110 refers to first mounting opening; 120 refers to second mounting opening; 130 refers to third mounting opening; 140 refers to first connecting opening; 150 refers to connecting buckle;
111 refers to first side edge; 112 refers to second side edge;
131 refers to third side edge; 132 refers to fourth side edge;
151 refers to magnetic member mounting position; 152 refers to connecting edge; 153 refers to first connecting hook; 154 refers to second connecting hook; 155 refers to first end; 156 refers to second end;
200 refers to storage member;
210 refers to storage portion; 220 refers to binding portion;
211 refers to storage hole; 212 refers to avoidance opening;
221 refers to first binding edge; 222 refers to second binding edge; 223 refers to connecting portion;
2211 refers to arc-shaped edge; 2212 refers to extension edge; 2213 refers to blocking protrusion; 2214 refers to protruding edge; 2215 refers to clamping opening;
2231 refers to mounting hole;
300 refers to hand-held electric power tool;
310 refers to handle portion; 320 refers to main body portion; and
400 refers to replacement head.

Specific embodiments of the present application have been shown through the above drawings, and will be described in more detail hereinafter. These drawings and written descriptions are not intended to limit the scope of concept of the present application in any way, but to explain the concept of the present application to those skilled in the art by referring to specific embodiments.

### DETAILED DESCRIPTION OF PREFERRED EMBODIMENTS

The technical solutions in embodiments of the present application are clearly and completely described hereinafter with reference to the drawings in the embodiments of the present application. Obviously, the described embodiments are merely some but not all of the embodiments of the present application. Based on the embodiments of the present application, all other embodiments obtained by those of ordinary skills in the art without going through any creative work should fall within the scope of protection of the present application.

In the embodiments of the present application, a hand-held electric power tool is provided with a plurality of replacement heads with different specifications and models. Illustratively, the hand-held electric power tool may be an electric drill, an electric screwdriver or an electric hammer. For example, when the hand-held electric power tool is the electric drill, the replacement head is a drill bit correspondingly, when the hand-held electric power tool is the electric screwdriver, the replacement head is a screwdriver bit correspondingly, and when the hand-held electric power tool is the electric hammer, the replacement head is an electric hammer driver bit correspondingly.

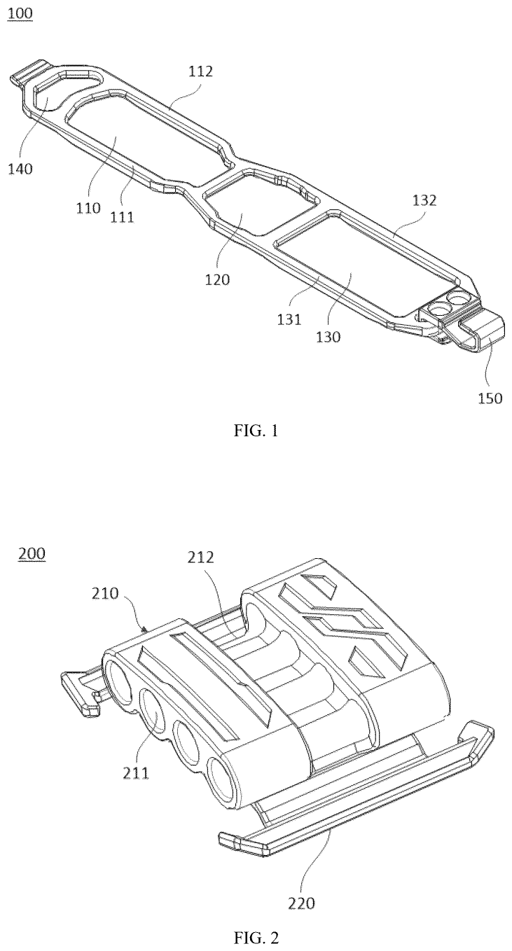

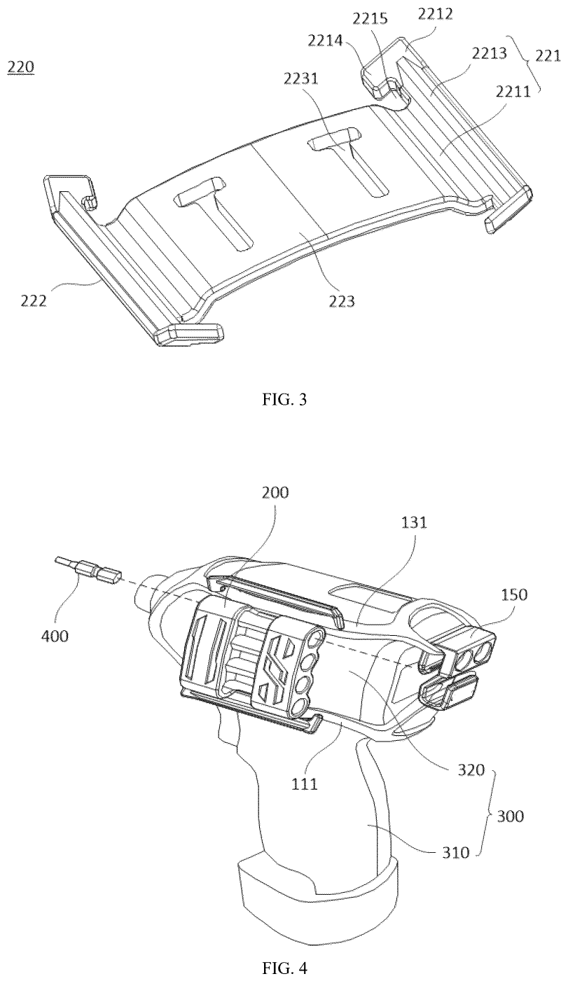

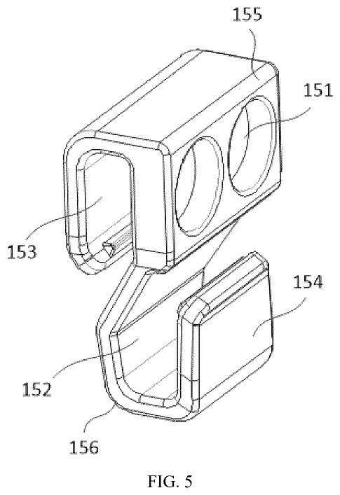

As shown in FIG. 1, FIG. 2 and FIG. 4, a replacement head external hanging device provided by an embodiment of the present application is used for being mounted on a hand-held electric power tool 300, wherein the replacement head external hanging device includes: a binding mounting belt 100 and a storage member 200, and the binding mounting belt 100 is configured to be wound on the hand-held electric power tool 300. The storage member 200 is provided with a storage portion 210, the storage portion 210 is configured to store and place a replacement head 400, and the storage member 200 is mounted on the hand-held electric power tool 300 through the binding mounting belt 100. A user may place a commonly used replacement head 400 in the storage member 200, when the user uses the hand-held electric power tool 300 and needs to replace the replacement head 400, a required replacement head 400 may be directly taken from the storage member 200 and mounted on the hand-held electric power tool 300, the removed replacement head 400 may be placed in the storage member 200, and by this arrangement, an appropriate replacement head 400 can be got quickly, so that the replacement of the replacement head 400 is more convenient, time for a user to rummage in a tool box or a tool kit for the replacement head 400 is saved, and the removed replacement head 400 can be placed in the storage member 200, which is convenient to store and not easy to lose.

It should be noted that a number of binding mounting belts 100 is not limited, and a winding mode of the binding mounting belt is not limited, wherein a plurality of binding mounting belts 100 may be provided, the plurality of binding mounting belts 100 are sequentially connected end to end and wound on the hand-held electric power tool 300. In the embodiment of the present application, one binding mounting belt 100 is taken as an example for description.

In addition, it is worth noting that, in the embodiment of the present application, the storage member is mounted on the hand-held electric power tool through the binding mounting belt, which means that the storage member and the binding mounting belt may be in an integrated or separated structure, that is to say, a matching mode between the storage member and the binding mounting belt may be that the storage member is mounted on the binding mounting belt, and the binding mounting belt is wound on the hand-held electric power tool, so that the storage member is mounted on the hand-held electric power tool through the binding mounting belt, wherein the storage member may be detachably or non-detachably mounted on the binding mounting belt, or the storage member and the binding mounting belt may be in the integrated structure. The matching mode between the storage member and the binding mounting belt may also be the following mode, that is, the storage member is mounted on the binding mounting belt by tightening the binding mounting belt. In the embodiment of the present application, the storage member being mounted on the binding mounting belt by tightening the binding mounting belt is taken as an example for detailed description.

In some embodiments of the present application, the binding mounting belt 100 is an elastic belt. Illustratively, the binding mounting belt 100 is a rubber belt.

In some embodiments of the present application, the storage member 200 is provided with a binding portion 220. The binding mounting belt 100 is provided with a tightening edge, and the tightening edge tightens and fixes the binding portion 220 between the tightening edge and the hand-held electric power tool 300. The binding portion 220 of the storage member 200 is tightened and fixed through the tightening edge, so that the storage member 200 is mounted on the hand-held electric power tool 300.

Illustratively, the tightening edge includes a first tightening edge and a second tightening edge. The binding portion 220 includes a first binding edge 221 and a second binding edge 222, the first binding edge 221 and the second binding edge 222 are located on two opposite sides of the storage member 200, the first binding edge 221 is tightened between the first tightening edge and the hand-held electric power tool 300, and the second binding edge 222 is tightened between the second tightening edge and the hand-held electric power tool 300. The first tightening edge and the second tightening edge respectively tighten two opposite sides of the storage member 200, so that the storage member 200 can be firmly tightened on the hand-held electric power tool 300.

As shown in FIG. 4, in the embodiment, the hand-held electric power tool 300 includes a main body portion 320 and a handle portion 310, and the handle portion 310 is connected with the main body portion 320.

As shown in FIG. 1 and FIG. 4, the binding mounting belt 100 includes a binding belt body and a connecting buckle 150, the binding belt body is provided with a first mounting opening 110 and a second mounting opening 120, and the first mounting opening 110 and the second mounting opening 120 are arranged at an interval in a length direction of the binding belt body. The binding belt body is sleeved on a junction of the handle portion 310 and the main body portion 320 from the first mounting opening 110, and the binding belt body is sleeved on a head portion of the main body portion 320 from the second mounting opening 120. That is to say, when the binding mounting belt 100 is wound on the hand-held electric power tool 300, the first mounting opening 110 is an avoidance opening through which the binding mounting belt 100 is sleeved on the handle portion 310, and the second mounting opening 120 is an avoidance opening through which the binding mounting belt 100 is sleeved on the head portion of the main body portion 320. When the binding mounting belt 100 is wound on the hand-held electric power tool 300, the binding belt body is sleeved on the junction of the handle portion 310 and the main body portion 320 from the first mounting opening 110, the binding belt body is sleeved on the head portion of the main body portion 320 from the second mounting opening 120, the connecting buckle 150 connects two ends of the binding belt body in the length direction, and the connecting buckle 150 is arranged at a tail end of the main body portion 320, so that the binding mounting belt 100 is wound on the hand-held electric power tool 300.

It should be noted that the head portion of the main body portion 320 is one side of the main body portion 320 on which an output end is arranged.

In some embodiments of the present application, one end of the handle portion 310 of the hand-held electric power tool 300 close to the main body portion 320 extends to the head portion of the main body portion 320 in an extending direction of the main body portion 320 (an axial direction of the output end of the main body portion 320) to form a handle extension edge 2212, and an end portion of the handle extension edge 2212 close to the head portion of the main body portion 320 is provided with an illuminating lamp. A light penetration opening is arranged between the first mounting opening 110 and the second mounting opening 120, the binding belt body between the first mounting opening 110 and the light penetration opening is tightened on one side of the handle extension edge 2212 far away from the main body portion 320, and the binding belt body between the second mounting opening 120 and the light penetration opening is tightened on one side of the handle extension edge 2212 close to the main body portion 320. Therefore, when the binding mounting belt 100 is mounted on the hand-held electric power tool 300 with the illuminating lamp on the handle extension edge 2212, the binding mounting belt 100 is avoided from sheltering the illuminating lamp.

It should be noted that the binding mounting belt 100 may or may not be provided with the light penetration opening, which will not be specifically limited herein. For the hand-held electric power tool 300 without the illuminating lamp on the handle extension edge 2212, as shown in FIG. 1, the binding mounting belt 100 may not be provided with light penetration opening. For the hand-held electric power tool 300 with the illuminating lamp on the handle extension edge 2212, the binding mounting belt 100 with the light penetration opening may be selected and used to avoid the binding mounting belt 100 from sheltering the illuminating lamp when the binding mounting belt 100 is mounted on the hand-held electric power tool 300.

Continuously referring to FIG. 1 and FIG. 4, in some embodiments of the present application, the binding belt body is provided with a third mounting opening 130, and the third mounting opening 130 is located on one side of the main body portion 320 far away from the handle portion 310. In a width direction of the binding belt body, two side edges of the binding belt body at the first mounting opening 110 are respectively a first side edge 111 and a second side edge 112, two side edges of the binding belt body at the third mounting opening 130 are respectively a third side edge 131 and a fourth side edge 132, and the first side edge 111 and the third side edge 131 are on the same side. The first side edge 111 serves as the first tightening edge, the third side edge 131 serves as the second tightening edge, and the storage portion 210 is located between the first side edge 111 and the third side edge 131, or, the second side edge 112 serves as the first tightening edge, the fourth side edge 132 serves as the second tightening edge, and the storage portion 210 is located between the second side edge 112 and the fourth side edge 132, or, the third side edge 131 serves as the first tightening edge, the fourth side edge 132 serves as the second tightening edge, and the storage portion 210 is located between the third side edge 131 and the fourth side edge 132. That is say, after the binding belt body is mounted on the hand-held electric power tool 300, the first side edge 111, the third side edge 131, the fourth side edge 132 and the second side edge 112 are sequentially spaced and adjacent in a circumferential direction of the main body portion 320 (an axial direction around the output end of the main body portion 320), and the storage member 200 may be mounted between the first side edge 111 and the third side edge 131, or between the second side edge 112 and the fourth side edge 132, or between the third side edge 131 and the fourth side edge 132, that is, the storage member 200 may be mounted on a left side, a right side or a top side of the main body portion 320, so that a mounting position is flexible, and the user may choose the mounting position according to comfort and habits.

Illustratively, in some embodiments of the present application, one end of the binding belt body in the length direction is provided with a first connecting opening 140, the other end of the binding belt body is provided with a second connecting opening, and the connecting buckle 150 connects the first connecting opening 140 and the second connecting opening, so that the binding mounting belt 100 is wound on the hand-held electric power tool 300.

As shown in FIG. 1, FIG. 4 and FIG. 5, in some embodiments of the present application, the connecting buckle 150 is provided with a magnetic member capable of adsorbing a ferromagnetic substance. Illustratively, the magnetic member may be a magnet. On one hand, the arrangement of the magnetic member facilitates the storage and placement of the binding mounting belt, and the magnetic member may be absorbed on an iron material, which facilitates the storage and reduces the possibility of loss; and on the other hand, the magnetic member is arranged on the connecting buckle 150, and located at a tail end of the main body portion 320, so that when the user uses the hand-held electric power tool, the magnetic member may absorb a screw and the like, which is convenient for the user to operate and reduces the trouble for the user to rummage for the screw. Illustratively, the magnetic member may be wrapped in the connecting buckle, or the connecting buckle may be provided with a mounting groove, and the magnetic member is mounted in the mounting groove. As shown in FIG. 1 and FIG. 4, the mounting position 150 of the magnetic member is located on one side of the connecting buckle 150 facing away from the hand-held electric power tool.

In some embodiments of the present application, as shown in FIG. 4 and FIG. 5, the connecting buckle 150 includes a connecting edge 152, a first connecting hook 153 and a second connecting hook 154. The connecting edge 152 is provided with a first end 155 and a second end 156 which are opposite, the first end 155 is bent towards one side of the connecting edge 152 close to the hand-held electric power tool to form the first connecting hook 153, and the second end 156 is bent towards one side of the connecting edge 152 far away from the hand-held electric power tool to form the second connecting hook 154. The first connecting hook 153 is hooked to one end of the binding belt body in the length direction, and the second connecting hook 154 is hooked to the other end of the binding belt body in the length direction. The magnetic member is wrapped in the connecting edge 152 and located in an area of the connecting member opposite to the first connecting hook 153. When the connecting buckle 150 connects the binding belt body, the first connecting hook 153 is hooked to one end of the binding belt body in the length direction first, and then the other end of the binding belt body in the length direction is pulled to be hooked on the second connecting hook 154. This arrangement is convenient for the operation of connecting the binding belt body by the connecting buckle 150, and the magnetic member is located in the area of the connecting member opposite to the first connecting hook 153, so that the magnetic member is located on one side of the connecting buckle 150 facing away from the hand-held electric power tool, which is convenient for the magnetic member to absorb the screw. Certainly, the user may also hook the second connecting hook 154 to one end of the binding belt body in the length direction first, and then hook the first connecting hook 153 to the other end of the binding belt body in the length direction, and a specific operation mode will not be specifically limited herein.

Illustratively, in an area of the connecting edge 152 corresponding to the second connecting hook 154, one surface oriented to the hand-held electric power tool is flush with one surface of the first connecting hook 153 oriented to the hand-held electric power tool. This arrangement allows one surface of the connecting buckle 150 oriented to the hand-held electric power tool to be attached to a tail end surface of the hand-held electric power tool, so that the binding mounting belt is more regular and beautiful after being mounted on the hand-held electric power tool.

In some embodiments of the present application, as shown in FIG. 2 and FIG. 3, the binding portion 220 further includes a connecting portion 223, the first binding edge 221 and the second binding edge 222 are respectively connected to two opposite sides of the connecting portion 223, and the storage portion 210 is connected to the connecting portion 223. Illustratively, the connecting portion 223, the first binding edge 221 and the second binding edge 222 may be in an integrated structure. This arrangement facilitates the processing and assembly of the storage member 200. Illustratively, the storage portion 210 and the binding portion 220 are made of different materials, wherein the storage portion 210 is made of a rubber material, which is convenient for inserting and removing the replacement head 400, and the binding portion 220 is made of a plastic material, which saves a cost.

Continuously referring to FIG. 2, FIG. 3 and FIG. 4, the first binding edge 221 includes an arc-shaped edge 2211, an extension edge 2212 and a blocking protrusion 2213. One side of the arc-shaped edge 2211 in a circumferential direction (an arc direction of the arc-shaped edge 2211) is connected with the connecting portion 223, the other side of the arc-shaped edge is connected with the extension edge 2212, and an opening of the arc-shaped edge 2211 faces away from the hand-held electric power tool 300. Two ends of the extension edge 2212 in a length direction respectively extend to two sides of the arc-shaped edge 2211 in a length direction, and extend out of two ends of the arc-shaped edge 2211 in the length direction, two ends of the extension edge 2212 extending out of the arc-shaped edge 2211 are respectively provided with a protruding edge 2214, and each protruding edge 2214 forms a clamping opening 2215 with an end portion of the arc-shaped edge 2211 on a corresponding side. The blocking protrusion 2213 is connected to one surface of the extension edge 2212 facing away from the hand-held electric power tool 300. The first binding edge 221 is configured to tighten the first tightening edge on the arc-shaped edge 2211, the blocking protrusion 2213 blocks the first tightening edge from being separated from the arc-shaped edge 2211, the first tightening edge is clamped in the clamping opening 2215, and the protruding edge 2214 is pressed on the first tightening edge to block the first tightening edge from being separated from the arc-shaped edge 2211. That is to say, as shown in FIG. 4, an arc-shaped groove formed by the arc-shaped edge 2211 is used for accommodating the first tightening edge, the blocking protrusion 2213 is used for blocking the first tightening edge from moving to one side far away from the storage portion 210, two protruding edges 2214 are respectively pressed on the first tightening edge for blocking the first tightening edge from moving to one side far away from the main body portion 320, and the blocking protrusion 2213 and the two protruding edges 2214 cooperate to block the first tightening edge from being separated from the arc-shaped groove.

In the embodiment, a structure of the second binding edge 222 is the same as that of the first tightening edge. That is to say, the second binding edge 222 also includes an arc-shaped edge 2211, an extension edge 2212 and a blocking protrusion 2213. In the embodiment, the structure of the second binding edge 222 is the same as that of the first tightening edge, excluding sizes. That is to say, sizes of the arc-shaped edge 2211, the extension edge 2212 and the blocking protrusion 2213 of the second binding edge 222 may be the same as or different from those of the arc-shaped edge 2211, the extension edge 2212 and the blocking protrusion 2213 of the first tightening edge, which will not be specifically limited herein.

Illustratively, as shown in FIG. 3, the connecting portion 223 is provided with at least one mounting hole 2231. The storage portion 210 is provided with a mounting protrusion, a number of mounting protrusions is the same as that of mounting holes 2231 and the mounting protrusions are in one-to-one correspondence with the mounting holes, and among corresponding mounting protrusions and mounting holes 2231, the mounting protrusion penetrates through the mounting hole 2231 and is limited and fixed by the mounting hole 2231.

In some embodiments of the present application, as shown in FIG. 2, the storage portion 210 is provided with at least one storage hole 211, and the storage hole 211 is configured to insert and store the replacement head 400, that is, the storage hole 211 is used for inserting the replacement head 400. An included angle between an axial direction of the storage hole 211 and an axial direction of an output end of the hand-held electric power tool 300 is less than 10°, such as 3°, 5° and 8°, that is to say, the axial direction of the storage hole 211 and the axial direction of the output end of the hand-held electric power tool 300 are approximately the same, and almost parallel, and this arrangement is convenient for the user to insert and remove the replacement head 400.

Continuously referring to FIG. 2, in some embodiments of the present application, a middle portion of the storage hole 211 is provided with an avoidance opening 212, and when a plurality of storage holes 211 are provided, the plurality of storage holes 211 are distributed at intervals in a first direction, the avoidance opening 212 of each storage hole 211 is penetrated, and the first direction is perpendicular to the axial direction of the storage hole 211. The arrangement of the avoidance opening 212 is convenient for taking a replacement head 400 with a short length inserted in the storage hole 211, and the replacement head 400 with the short length is easy to be hidden in the storage hole 211, which is inconvenient to take the replacement head at this time. However, the middle portion of the storage hole 211 is provided with the avoidance opening 212, and the user may push the replacement head 400 out of the storage hole 211 from the avoidance opening 212. Moreover, the avoidance opening 212 divides the storage hole 211 into two sections, and the two sections of the storage hole 211 may be respectively used for inserting the replacement head 400. In addition, when a plurality of storage holes 211 are provided, and the avoidance opening 212 of each storage hole 211 is penetrated, this arrangement makes each penetrated avoidance opening 212 form a larger opening, which is convenient for the user to operate.

The embodiment of the present application further provides a hand-held electric power tool assembly, the hand-held electric power tool assembly includes a hand-held electric power tool 300 and the replacement head external hanging device according to any one of the solutions above, wherein the binding mounting belt 100 of the replacement head external hanging device is wound on the hand-held electric power tool 300, and the storage member 200 of the replacement head external hanging device is mounted on the hand-held electric power tool 300 through the binding mounting belt 100.

After considering the specification and practicing the present disclosure, a person skilled in the art may easily conception of other implementations of this application. The present application is intended to cover any variations, uses, or adaptive changes of the present application. These variations, uses, or adaptive changes follow the general principles of the present application and include common general knowledge or common technical means in the art, which are not disclosed in the present application. The specification and the embodiments are considered as merely exemplary, and the scope and spirit of this application are pointed out in the following claims.

It should be understood that the present application is not limited to the precise structures described above and shown in the drawings, and various modifications and changes can be made without departing from the scope of the present application. The scope of the present application is subject only to the appended claims.

We claim:

1. A replacement head external hanging device used for being mounted on a hand-held electric power tool, wherein the replacement head external hanging device comprises:
a binding mounting belt, wherein the binding mounting belt is configured to be wound on the hand-held electric power tool; and
a storage member, wherein the storage member is provided with a storage portion, the storage portion is configured to store and place a replacement head, and the storage member is mounted on the hand-held electric power tool through the binding mounting belt.

2. The replacement head external hanging device according to claim 1, wherein the binding mounting belt is an elastic belt.

3. The replacement head external hanging device according to claim 1, wherein the storage member is provided with a binding portion;
the binding mounting belt is provided with a tightening edge, and the tightening edge tightens and fixes the binding portion between the tightening edge and the hand-held electric power tool; and
the binding portion of the storage member is tightened and fixed through the tightening edge, so that the storage member is mounted on the hand-held electric power tool.

4. The replacement head external hanging device according to claim 3, wherein the tightening edge comprises a first tightening edge and a second tightening edge; and
the binding portion comprises a first binding edge and a second binding edge, the first binding edge and the second binding edge are located on two opposite sides of the storage member, the first binding edge is tightened between the first tightening edge and the hand-held electric power tool, and the second binding edge is tightened between the second tightening edge and the hand-held electric power tool.

5. The replacement head external hanging device according to claim 4, wherein the hand-held electric power tool comprises a main body portion and a handle portion, and the handle portion is connected with the main body portion;
the binding mounting belt comprises a binding belt body and a connecting buckle, the binding belt body is provided with a first mounting opening and a second mounting opening, and the first mounting opening and the second mounting opening are arranged at an interval in a length direction of the binding belt body;
the binding belt body is sleeved on a junction of the handle portion and the main body portion from the first mounting opening, and the binding belt body is sleeved on a head portion of the main body portion from the second mounting opening; and
the connecting buckle connects two ends of the binding belt body in the length direction, and the connecting buckle is arranged at a tail end of the main body portion.

6. The replacement head external hanging device according to claim 5, wherein one end of the handle portion close to the main body portion extends to the head portion of the main body portion in an extending direction of the main body portion to form a handle extension edge, and an end portion of the handle extension edge close to the head portion of the main body portion is provided with an illuminating lamp;
a light penetration opening is arranged between the first mounting opening and the second mounting opening;
the binding belt body between the first mounting opening and the light penetration opening is tightened on one side of the handle extension edge far away from the main body portion; and
the binding belt body between the second mounting opening and the light penetration opening is tightened on one side of the handle extension edge close to the main body portion.

7. The replacement head external hanging device according to claim 5, wherein the binding belt body is provided with a third mounting opening, and the third mounting opening is located on one side of the main body portion far away from the handle portion;
in a width direction of the binding belt body, two side edges of the binding belt body at the first mounting opening are respectively a first side edge and a second side edge, two side edges of the binding belt body at the third mounting opening are respectively a third side edge and a fourth side edge, and the first side edge and the third side edge are on the same side; and
the first side edge serves as the first tightening edge, the third side edge serves as the second tightening edge, and the storage portion is located between the first side edge and the third side edge, or, the second side edge serves as the first tightening edge, the fourth side edge serves as the second tightening edge, and the storage portion is located between the second side edge and the fourth side edge, or, the third side edge serves as the first tightening edge, the fourth side edge serves as the second tightening edge, and the storage portion is located between the third side edge and the fourth side edge.

8. The replacement head external hanging device according to claim 5, wherein the connecting buckle is provided with a magnetic member capable of adsorbing a ferromagnetic substance.

9. The replacement head external hanging device according to claim 6, wherein the connecting buckle comprises a connecting edge, a first connecting hook and a second connecting hook;
the connecting edge is provided with a first end and a second end which are opposite, the first end is bent towards one side of the connecting edge close to the hand-held electric power tool to form the first connecting hook, and the second end is bent towards one side of the connecting edge far away from the hand-held electric power tool to form the second connecting hook;
the first connecting hook is hooked to one end of the binding belt body in the length direction, and the second connecting hook is hooked to the other end of the binding belt body in the length direction; and
the magnetic member is wrapped in the connecting edge and located in an area of the connecting member opposite to the first connecting hook.

10. The replacement head external hanging device according to claim 4, wherein the binding portion further comprises a connecting portion;
the first binding edge and the second binding edge are respectively connected to two opposite sides of the connecting portion; and
the storage portion is connected to the connecting portion.

11. The replacement head external hanging device according to claim 10, wherein the first binding edge comprises an arc-shaped edge, an extension edge and a blocking protrusion;
one side of the arc-shaped edge in a circumferential direction is connected with the connecting portion, the other side of the arc-shaped edge is connected with the extension edge, and an opening of the arc-shaped edge faces away from the hand-held electric power tool;
two ends of the extension edge in a length direction respectively extend to two sides of the arc-shaped edge in a length direction, and extend out of two ends of the arc-shaped edge in the length direction, two ends of the extension edge extending out of the arc-shaped edge are respectively provided with a protruding edge, and each protruding edge forms a clamping opening with an end portion of the arc-shaped edge on a corresponding side;
the blocking protrusion is connected to one surface of the extension edge facing away from the hand-held electric power tool;
the first binding edge is configured to tighten the first tightening edge on the arc-shaped edge, the blocking protrusion blocks the first tightening edge from being separated from the arc-shaped edge, the first tightening edge is clamped in the clamping opening, and the protruding edge is pressed on the first tightening edge to block the first tightening edge from being separated from the arc-shaped edge; and
a structure of the second binding edge is the same as that of the first tightening edge.

12. The replacement head external hanging device according to claim 1, wherein the storage portion is provided with at least one storage hole; and
the storage hole is configured to insert and store the replacement head.

13. The replacement head external hanging device according to claim 12, wherein a middle portion of the storage hole is provided with an avoidance opening; and
when a plurality of storage holes are provided, the plurality of storage holes are distributed at intervals in a first direction, the avoidance opening of each storage hole is penetrated, and the first direction is perpendicular to an axial direction of the storage hole.

14. A hand-held electric power tool assembly, comprising a hand-held electric power tool and the replacement head external hanging device according to claim 1, wherein:
the binding mounting belt of the replacement head external hanging device is wound on the hand-held electric power tool, and the storage member of the replacement head external hanging device is mounted on the hand-held electric power tool through the binding mounting belt.
